(19) United States
(12) Patent Application Publication
(10) Pub. No.: US 2004/0263166 A1
(43) Pub. Date: Dec. 30, 2004

(54) Magnetic resonance apparatus and method with real-time imaging control dependent on equipment-specific and patient-specific limits

(76) Inventor: Thomas Kluge, Hirschaid (DE)

Correspondence Address: SCHIFF HARDIN LLP, Patent Department, 6600 Sears Tower, 233 South Wacker Drive, Chicago, IL, 60606, US

(21) Appl. No.: 10/831,747

(22) Filed: Apr. 23, 2004

(30) Foreign Application Priority Data
Apr. 23, 2003 (DE) 103 18 428.7

(51) Int. Cl. G01V 3/00

(52) U.S. Cl. 324/309

(57) ABSTRACT

In a method and apparatus for real-time-controlled optimized magnetic resonance imaging taking into account equipment-specific and patient-specific limits. This object is achieved according to the present invention by a method for optimized magnetic resonance imaging taking into account equipment-specific and patient-specific limits, wherein data acquisition software into the system computer for conducting an MR scan of a patient, monitoring software estimates whether, with a configuration of the data acquisition software made by the user, limits for critical quantities can be exceeded in the subsequent measurement, the measurement is limited in the case of a positive result for the estimate, a time slice for the measurement is computed by the data acquisition software taking into account current values of the critical quantities, of the time slice is transmitted to the control computer or sequence controller for executing and the steps of computation and transmission of a time slice are repeated until the measurement is complete.

### BACKGROUND OF THE INVENTION

1. Field of the Invention

The present invention relates in general to nuclear spin tomography (synonym: magnetic resonance tomography (MRT) as used in medicine for investigating patients. The present invention relates particularly to a method for real-time-controlled optimization of magnetic resonance imaging, taking into account equipment- and patient-specific limits.

2. Description of the Prior Art

MRT is based on the physical phenomenon of nuclear spin resonance and has been successfully used as an imaging technique for over 15 years in medicine and biophysics. In this modality, an object is exposed to a strong, constant magnetic field. In this manner, the nuclear spins of the atoms in the object become aligned after having been previously randomly oriented. Radio-frequency energy can now excite these “ordered” nuclear spins to produce a certain oscillation. In MRT, this oscillation produces the actual measurement signal that can be acquired by suitable receiving coils. By the use of inhomogeneous magnetic fields generated by gradient coils, the measurement object can be spatially encoded in all three spatial directions. The technique allows a free choice of the slice to be imaged, it being possible in this manner to acquire sectional images of the human body in all directions. As a sectional imaging technique used in medical diagnostics, MRT is characterized above all as a “non-invasive” method of investigation with a versatile contrast capability. MRT has developed into a technique that is far superior to X-ray computed tomography (CT).

In an MRT measurement, one generally starts with the choice of a certain imaging sequence (e.g., turbo spin echo=TSE, half Fourier acquired single shot turbo spin echo=HASTE, etc.) and the determination of the parameters which characterize the sequence (e.g., resolution, measurement field size, field of view=(FOV), number of slices, repetition time TR, echo time TE, flip angle α, width of the RF excitation pulses, etc.). The parameters of the imaging sequence (also known as the “measurement protocol”) are proposed by software, but also can be entered or rather modified by the user via a user interface which is connected to the system controller or the system computer (see the following description of FIG. 1). Normally, the user interface, represented on a screen as a screen mask, has windows in which the numerical values of the respective parameters are displayed, or entered via a keyboard. If a window of this sort has a virtual slider, the numerical value can be set by operating the slider, normally with the mouse.

Due to physical-technical conditions, MR imaging sequences are generally subject to different restrictions, so that a measurement protocol planned with corresponding parameters cannot be run under certain circumstances. In general, this involves:

a) a limited capability of the RF transmitter

b) a limited capability of the respective gradient amplifier

c) a limitation of the gradient change rates which under certain circumstances can produce painful stimulations as well as

d) a limited specific absorption rate (SAR) of the patient under investigation

Particularly in spin-echo and multi-echo-refocused MR sequences (TSE, HASTE, etc.), restrictions a) and d) are critical.

The structure of a TSE sequence of this sort is shown schematically in FIG. 2a. Excitation, refocusing, frequency and phase encoding take place like with a usual spin echo sequence. The difference is that the phase encoding is refocused after the read-out echo and a new phase encoding step is used after each further 180° pulse. Thus, a number of phase-encoded echoes are measured per excitation by a 90° RF excitation pulse. Here, the number of echoes used is directly proportional to the measurement time shortening. If TSE technology is combined with the half-Fourier technology, then this is referred to as a “HASTE sequence”.

Whereas with the two sequences mentioned (TSE, HASTE) the 90° excitation pulse makes a relatively low contribution to the RF energy emitted into the patient, each 180° refocusing pulse produces a significant additional loading of absorbed RF radiation in the patient. The permissible SAR thus can be easily (i.e., quickly) exceeded. Likewise, the capability of the RF transmitter can be overloaded beyond its limits in the case of an energy input that is too high, or in the case of an echo time that is too short.

In order to still be able to carry out the respective MRT measurement, compromises are needed in terms of the measurement parameters, which will impair to some extent the image quality. The problem becomes worse as the gradient and/or RF) field strengths become higher.

Conventionally, an attempt has been made prior to the actual measurement, using suitable software, to estimate whether with the defined sequence the limitations are exceeded and thus violated (“look-ahead algorithm”). If there is a violation, using an adaptation or rather variation of the measurement parameters, which are shown to the user, for example, in a pop-up window, an attempt is made to arrive within the permissible region.

Common parameter changes with regard to the SAR limits are as follows:

Increasing the repetition time

Requiring measurement pauses between the sequence passes

Reducing the number of layers

Reducing the flip angles of the refocusing pulses as well as

Lengthening the duration of the RF excitation pulses

A disadvantage is that measures of this sort lead to a lengthening of the effective measurement time, the image quality being impaired as a result due to the relaxation (which remains the same).

Also disadvantageous is the fact that in real-time measurements such estimates are not sufficiently accurate to guarantee that during the measurement the limitations will still not violated. Real-time measurements are, for example, measurements, which are triggered by anatomical events (e.g., heart contraction status, diaphragm position, etc.) using an ECG measurement, a respiratory belt, navigator rod measurement, etc. The exact course of such measurements cannot be foreseen as a general rule. It may occur that, in a given time window an increased number of excitation or refocusing pulses are switched, causing the limit of the SAR or the limit of the RF transmitter to be exceeded. Accordingly, software and hardware components are used in prior art systems to monitor compliance with the limitations during the measurement (i.e. online) and to interrupt the measurement if the limitations are exceeded in order to protect the system (and above all the patient).

### SUMMARY OF THE INVENTION

An object of the present invention is to provide a method which monitors the aforementioned limitations in real-time and—before they can be exceeded—modifies the measurement such that no measurement interruption occurs and measurement data acquisition can take place with uniform image quality.

This object is achieved according to the present invention by a method for optimized magnetic resonance imaging taking into account equipment-specific and patient-specific limits, wherein data acquisition software into the system computer for conducting an MR scan of a patient, monitoring software estimates whether, with a configuration of the data acquisition software made by the user, limits for critical quantities can be exceeded in the subsequent measurement, the measurement is limited in the case of a positive result for the estimate, a time slice for the measurement is computed by the data acquisition software taking into account current values of the critical quantities, of the time slice is transmitted to the control computer or sequence controller for executing and the steps of computation and transmission of a time slice are repeated until the measurement is complete. According to the invention, the last three named steps are performed in real-time.

The critical quantities are equipment-specific and/or patient-specific.

According to the invention, the current values of the critical quantities are transferred by the monitoring software to the data acquisition software in real-time.

The measurement software is provided with a number of alternative time slices to be computed.

An algorithm makes a selection according to the invention based on the current values of the critical quantities from the alternative time slices in a manner such that by transmitting and processing the selected time slice, no limit of the critical quantities is exceeded.

The time slice in one embodiment is formed exclusively of the RF excitation pulse.

In a further embodiment, the time slice has no pulses of any sort.

For the safety of the patient as well as the system, the monitoring software determines prior to and during the transmission of each time slice, the critical quantities and interrupts the measurement the permissible limits are exceeded.

This is also possible with monitoring hardware that determines the critical quantities prior to and during the transmission of each time slice and interrupts the measurement if the permissible limits are exceeded.

The above object also is achieved in accordance with the invention by an MRT with a system computer and a sequence controller as well as measurement and control units for implementing the method described above.

The above object also is achieved by a computer software product causes a method as described above to be implemented when loaded into a computing device of an MRT system and executed thereby.

### DESCRIPTION OF THE DRAWINGS

FIG. 1 is a schematic block diagram of an MRT system constructed and operating according to the invention.

FIG. 2a schematically illustrates an example of a time slice of a first embodiment in the form of a TSE sequence.

FIG. 2b schematically illustrates an example of a time slice of a second embodiment, which loads (stresses) the system less than the first embodiment.

FIG. 3 schematically illustrates the conventional operation of an MRT measurement in a flowchart.

FIG. 4 schematically illustrates the procedure according to the invention that is implemented in step S10 of the conventional operation.

FIG. 5a schematically illustrates the transmission behavior over time of software with respect to the hardware according to the prior art.

FIG. 5b schematically illustrates the transmission behavior over time of the software with respect to the hardware in real-time according to the invention.

### DESCRIPTION OF THE PREFERRED EMBODIMENTS

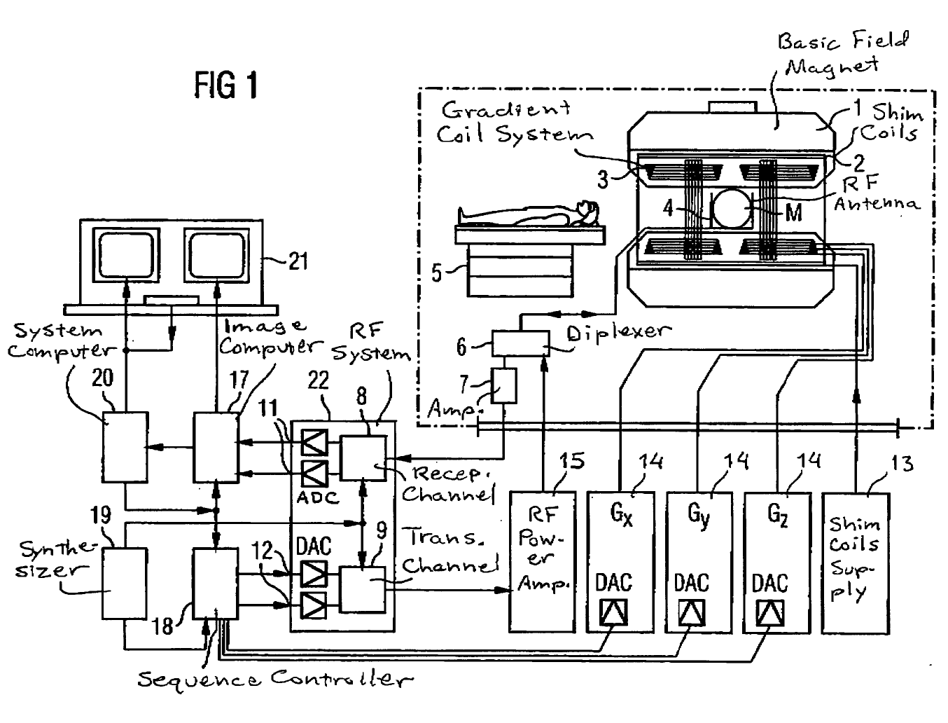

FIG. 1 is a schematic representation of a magnetic resonance imaging (tomography) system for producing a nuclear spin image of an object according to the present invention. The basic components of the MRT system correspond to the design of a conventional MRT system, with the exception of the differences described below. A basic field magnet 1 produces a strong magnetic field that is constant over time for polarization or alignment of the nuclear spins in the investigation region of an object such as a part under investigation of a human body. The high homogeneity of the basic magnetic field required for the magnetic resonance measurement is defined in measurement volume M (for example, spherical volume) into which the parts under investigation of the human body are introduced. In order to support the homogeneity requirements and particularly to eliminate influences that are invariable over time, shim plates made of ferromagnetic material are arranged at suitable locations. Influences that are variable over time are eliminated using shim coils 2, which are controlled by a shim power supply 15.

In the basic field magnet 1, a cylinder-shaped gradient coil system 3 is mounted which is formed of three windings (coils). Each winding is supplied by an amplifier 14 with current for generating a linear gradient field in the respective direction of the Cartesian coordinate system. Here, the first winding of the gradient field system 3 produces a gradient Gₓ in the x direction, the second winding a gradient G_{y} in the y direction, and the third winding a gradient G_{z} in the z direction. Each amplifier 14 includes a digital-analog converter that is controlled by a sequence controller 18 for generating gradient pulses at the correct time.

Within the gradient field system 3, there is a radio-frequency antenna 4 that converts the pulses emitted by an RF power amplifier 13 into a magnetic alternating field for exciting the nuclei and alignment of the nuclear spins of the object under investigation, or the region of the object under investigation. The RF antenna 4 has one or more RF transmit coils and one or more RF receiving coils, possibly in an arrangement of component coils (generally known as “coil arrays” or “phased array coils”). The RF receiving coils of the radio-frequency antenna 4, detect the alternating field emanating from the precessing nuclear spins. In general these signals are spin echo signals caused by a pulse sequence from one or a number of RF pulses and one or more gradient pulses. The received signal is converted into a voltage that is fed via an amplifier 7 to an RF channel 8 of an RF system 22. The RF system 22 also includes a transmission channel 9 in which the pulses for the excitation of the magnetic resonance signals are generated. These pulses are a pulse sequence determined digitally by the system computer 20 in the sequence controller 18 digitally as a sequence of complex numbers. This sequence of numbers is fed as a real part and an imaginary part via respective inputs 12 to a digital-analog converter in the RF system 22, and from this to the transmission channel 9. In the transmission channel 9, the pulse sequences are modulated with an RF carrier signal, the base frequency of which corresponds to the resonant frequency of the nuclear spins in the measurement volume.

The switchover from transmission mode to reception mode takes place by means of a transmit-receive diplexer 6. The RF transmit coil of the radio-frequency antenna 4 radiates the RF pulses for exciting the nuclear spins into the measurement volume M and detects the resulting echo signals via the RF receive coils. The resonance signals obtained in this manner are demodulated in the reception channel 8 of the RF system 22 in a phase-sensitive manner and are converted, via respective analog-digital converters, into a real part and an imaginary part of the measurement signal. Using an image processor 17, an image is reconstructed from the measurement data obtained in this way. The management of the measurement data, the image data and the control programs takes place via the system computer 20. Based on an input with control programs, the sequence controller 18 controls the generation of the pulse sequences desired in each case and the corresponding scanning k-space. In particular, the sequence controller 18 controls the switching at the correct time of the gradients, the emission of the RF pulses with a defined phase and amplitude as well as the reception of the magnetic resonance signals. The time base for the RF system 22 and the sequence controller 18 is provided by a synthesizer 19. The selection of suitable control programs for generating a magnetic resonance image as well as the presentation of the generated image takes place via a terminal 21, which includes a keyboard as well as one or more display screens.

As explained above, certain components (such as the gradient amplifier 14 of the gradient coils, the RF resonator 4 and the ADC) are subject to physical-technical constraints due to their limited capability. Further limitations of the RF radiation and/or of the gradient change rate (gradient slew rate) are determined, for example, by patient-specific limits (such as the specific absorption rate (SAR) and/or the gradient stimulation).

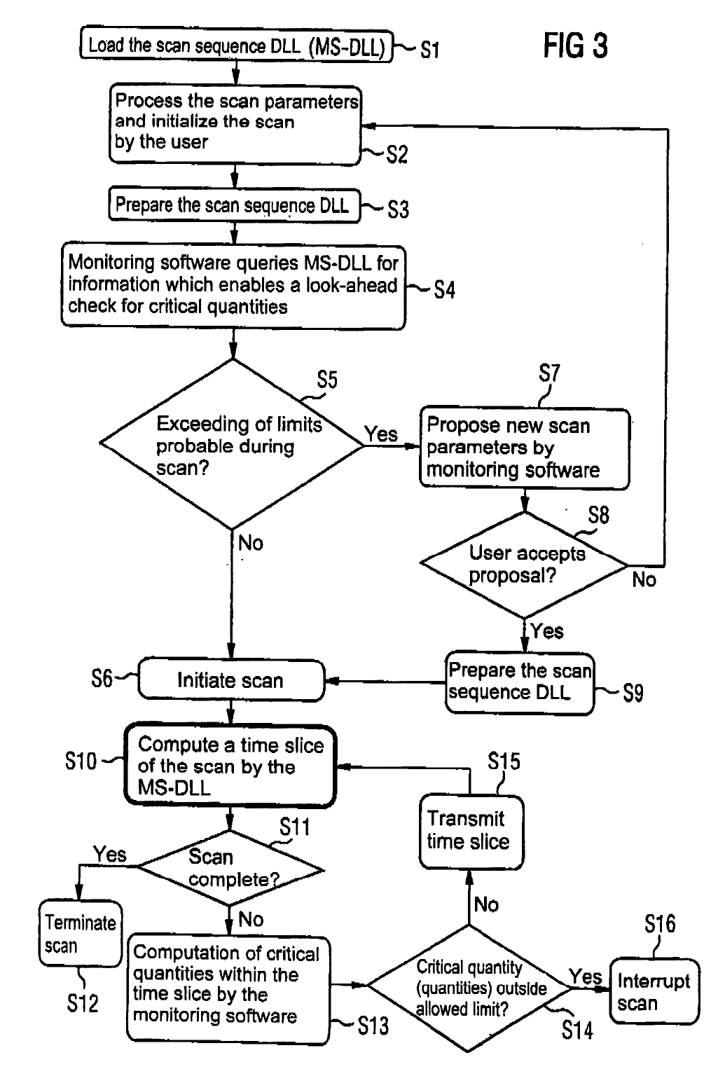

For this reason, according to the prior art a check is made by the MRT system beforehand, i.e., during the preparation (i.e., after the data acquisition software for the scan is loaded into the system) of the respective scan, as to whether limits exceeding one of these is probable. Using monitoring software and/or hardware during the monitoring is carried out, which might possibly interrupt the data acquisition. This known method, which serves as a starting point for the present invention—will be described in detail based on the flowchart in FIG. 3.

The procedure begins with step S1 in which the user selects from a software library a measurement (scan) sequence dynamic link library (MS-DLL), which implements on the system computer 20 in connection with the sequence controller 18 a desired measurement sequence (e.g., a turbo spin echo sequence=TSE or similar measurement sequences). In order to be able to carry out an optimum or desired measurement in terms of various aspects (resolution, contrast, measurement duration), it is necessary to make suitable settings of the measurement parameters (flip angle, repetition time, slice thickness, etc.) prior to the measurement. This takes place in step S2 by the user via a graphical user interface (GUI) on the monitor of the terminal 21. Normally, defaults setting are initially proposed for the user that can be varied with permitted intervals using the mouse and/or keyboard. Once the parameters are set, the user is able to initialize the scan (data acquisition) using a virtual button. Immediately thereafter, in a third step S3 the MS-DLL is prepared based on the entered parameters in the system computer 20, i.e., it is configured in terms of the software so that the desired scan can be carried out. Prior to the actual start of the scan in step S6, however, an estimate is made by monitoring software MSW as to whether critical values (patient- or equipment-specific, see above) can be exceeded with the present MS-DLL configuration. For this purpose, the MSW queries in a step S3 the previously prepared MS-DLL for information that allows the MSW to make a look-ahead check for these critical quantities.

Normally, the equipment-specific limits are checked already in step S2. For software-related reasons, the check of the patient-specific limits takes place in steps S3 to S5.

In the step S5, the decision is made as to whether all of the critical values will presumably remain in permitted ranges. If so, then in step S6 the scan is started. If there is even a small probability that at least one critical limit will be exceeded, then the parameter setting procedure is repeated via the user interface. For this purpose, a corrected or modified parameter data set computed by the MSW can be automatically proposed to the user in a step S7 via a pop-up window. This parameter data set can be accepted or rejected by the user in a further step S8. If the user accepts the modified parameter data set, in a step S9 the MS-DLL is prepared anew according to the modified data set and the scan is started subsequently in step S6. If the proposal is rejected by the user, then it is possible for the user to carry out the step S2 anew. The steps S3 to S5 follow accordingly; prior to the start of the scan (step S6), an estimate is made anew.

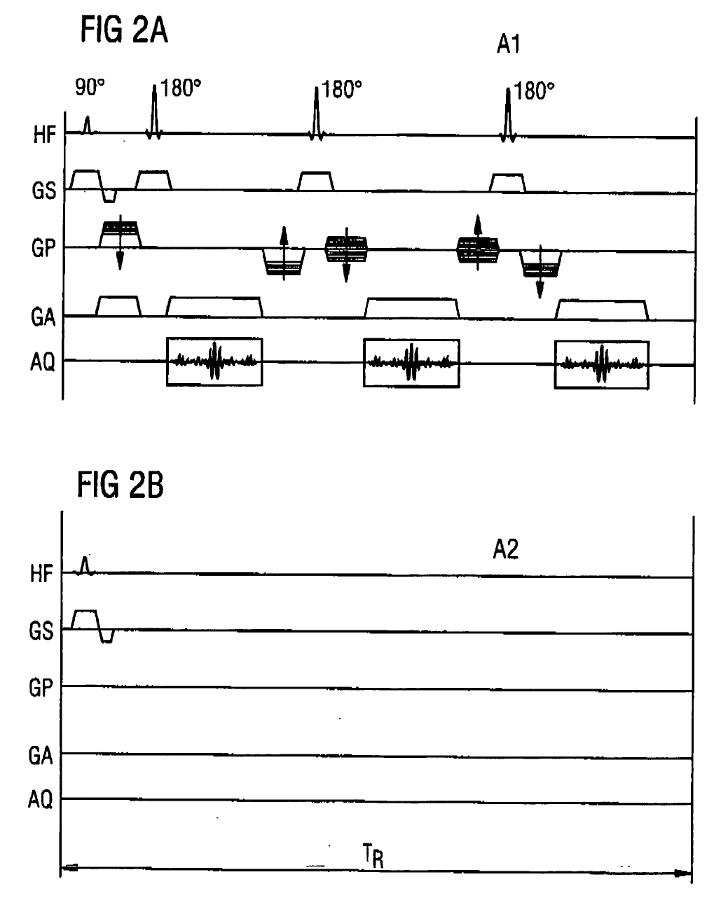

If a start of the measurement (step S6), occurs after steps 55 or 58 then the MS-DLL computes in step S10 what is known as a “time slice” for the initialized scan. A time slice of this sort is a combination defined by the parameter configuration of RF and gradient pulses. In the case of a TSE sequence, a time slice can include a number of RF excitation pulses with the associated refocusing pulses and the corresponding gradient pulses, the amplitude of the phase encoding gradient of the respective RF excitation naturally differing. A TSE time slice with a 90° excitation pulse and three 180° excitation pulses is shown in FIG. 2a. The slice selection gradient GS is switched during each RF pulse (excitation and refocusing pulses); the data acquisition takes place between the slice selection and phase encoding gradients.

Particularly in a TSE experiment, due to the number of RF-intensive refocusing pulses, the energy input into the tissue of a patient under investigation is very high. If the permissible maximum value of the RF absorption (SAR) is exceeded, then there exists an acute risk to the patient. The situation is similar with the gradient change rate that—if a corresponding limit is exceeded—can cause painful stimulations. Both endanger the patient and must be avoided in any case. As previously mentioned, the estimation algorithm of steps S2 to S9 (“look-ahead algorithm”) is not sufficiently accurate in real-time scans (i.e., scans which are triggered by anatomical events such as the heart contraction state, diaphragm position, etc. using an CKG measurement, navigator rod measurement, etc.) to guarantee that during the scan the limitations will not be violated. For this reason, the MSW computes in a step S13 the critical quantities for each time slice (or rather corresponding hardware component measures the critical value). In a step S14, the value computed (or measured) in each case of each critical quantity is compared with the corresponding limit. If any of the limits is exceeded, the scan is immediately interrupted in a step S16. Only if all of the critical quantities come to lie in permitted ranges is the measurement continued by, in a step S15, the corresponding time slice being sent to the system computer 20 or the sequence controller 18 being executed by them. Subsequently, step S10 with the computation of the next time slice (of the desired sequence) is repeated, the time slice checked and possibly sent until, in a step S11, the last time slice is detected (the data acquisition is completed) and in a step S12 the scan is properly terminated.

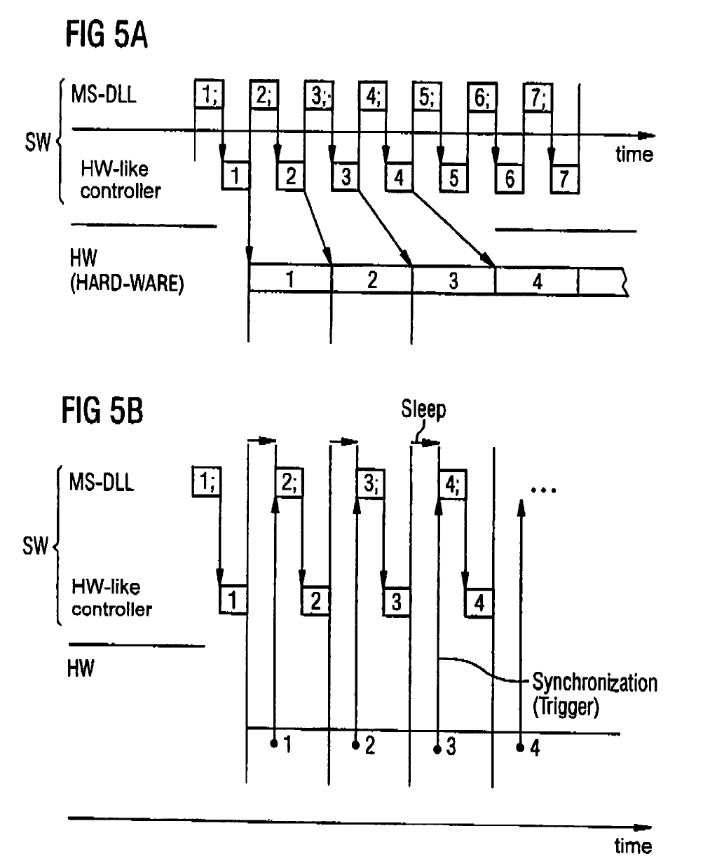

The progress over time according to the prior art of the conversion of the compiled code of the MS-DLL into a hardware command structure at the level of a network layer, which initiates the execution of the measurement by intermittent transmission and processing of time slices on the hardware, is shown schematically in FIG. 5a. The topmost block represents the compiled code of the prepared MS-DLL, each numeral representing the next time slice to be transmitted. The middle layer (network layer) is a software environment in which the elements of the individual time slices, e.g., gradient pulses and RF pulses, are present in a form that can be understood by the hardware. The processing carried out in real-time of the respective sequence itself using hardware is represented in the last line. The concept of FIG. 5a is that the software (topmost and middle layer) forwards or processes each command as quickly as possible, i.e., as fast as is allowed by the computer or control unit, so that a time offset of the time slices arises between hardware and software. Thus, for example, on the software level the time slice 7 is processed while on the hardware level the measurement of the time slice 4 is still running. The check of critical quantities using verification software or hardware takes place according to steps S13/S14 on the level of the network layer and the hardware. There is no acknowledgement back to the topmost layer so that an exceeding of critical quantities is not detected there so that it can then be counteracted. If a limit exceeding is determined, then the measurement is interrupted immediately as a consequence according to step S16.

The present invention modifies the previously explained method from steps S1 to S16 such that an interruption of an MRT scan is generally avoided.

For this purpose, operation of the MRT system in real-time mode is necessary which will be explained based on FIG. 5b:

In comparison to the non-real-time operation according to FIG. 5a, the MS-DLL requests, according to FIG. 5b, that the hardware transmit a synchronization signal (trigger). Before the MS-DLL computes the time slice 2, it waits for the synchronization signal. The waiting is designated in FIG. 5b as “sleep”. By means of this waiting, the software is always one step ahead of the hardware. The consequence is that the MS-DLL has sufficient time to make determinations, still during the current measurement (on the hardware level), for the next time slice as to whether the patient and/or system will be overloaded. A real-time mode of this sort in the system thus means that the computation of the next time slice is synchronized with the current scan.

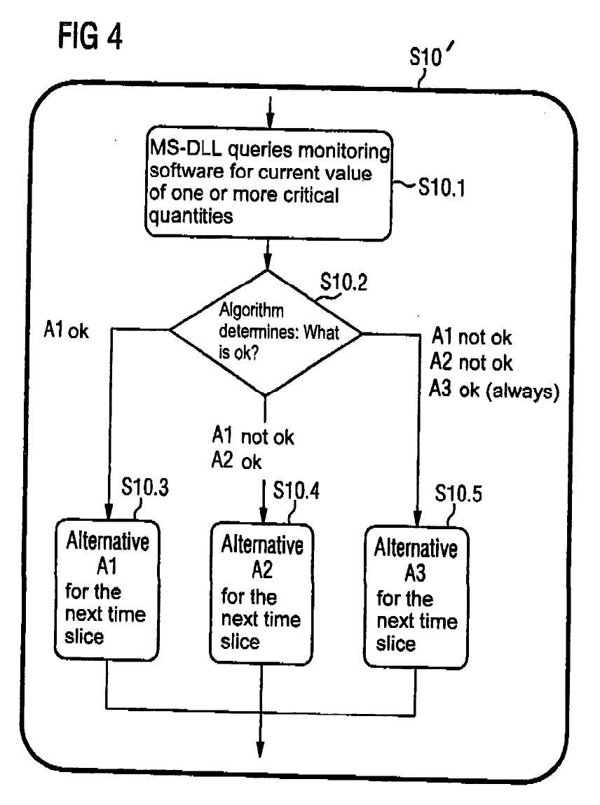

If the measurement runs in a real-time mode of this sort, then the time slice computation can be modified according to step S10′ according to the invention, shown in FIG. 4.

As before, step S10′ is used to compute the next time slice which implements on the hardware the corresponding RF or gradient pulse train sequence. According to the invention, the system is given the opportunity prior to transmitting the time slice to check whether the current time slice leads in relation to the history of the system (i.e., with the previously transmitted time slices) to a critical limit being executed. For this purpose, the MS-DLL communicates during the scan in short time intervals according to step S10.1, with the software or hardware components (monitoring components: MSW, MHW) that are responsible for monitoring the limitations. The MS-DLL queries the MSW and/or the MHW about the current value of one or a plurality of critical quantities. An algorithm implemented in the MS-DLL selects, in a step S10.2, from a series of possible time slices the time slice which guarantees, taking into account the previously transmitted time slices and the time slice just sent, a maximum information gain without exceeding a critical limit. In general, a high information gain in the MRT imaging is associated with a corresponding high loading of the system itself or of the patient under investigation. This means, vice versa, that corresponding restrictions must be made for relieving the system or the patient by sending alternative time slices. In FIG. 4, for example, in the selections S10.3, S10.4 and S10.5, three time slice alternatives A1, A2 and A3 are indicated, A1 representing a conventional time slice of a conventional sequence (such as a TSE sequence). One such is shown in FIG. 2a and was previously explained. In a time slice according to A1, due to the multiplicity of energetically intensive refocusing pulses, the SAR can easily be exceeded. If during the scan via the algorithm and through the monitoring software exceeding as a limit is determined based on the previously transmitted time slices as well as the knowledge of the nature of the time slice A1, then the time slice A1 is not transmitted. Instead, a check is made whether the time slice A2 can be transmitted. In the case of the SAR being exceeded, the alternative can be considering a time slice A2 in which the RF radiation is reasonably reduced. A time slice of this sort is shown in FIG. 2b. In A2 according to FIG. 2b, all of the refocusing pulses are omitted; only the 90° excitation pulse is maintained which upon radiation of a number of A2 time slices with a corresponding repetition time maintains the steady-state signal and thus the nuclear spin resonance of the tissue under investigation. In A2, all of the gradient pulses are omitted since they lose their meaning without refocusing pulses. The time slice A2 has the same duration as time slice A1.

If the algorithm determines, such as by querying the monitoring software, which exceeding a limit also is possible in the time slice A2, then a third alternative is considered which in this case (FIG. 4, step S10.5) can be transmitted in any case (even in the worst case). A time slice A3 of this sort exhibits no pulses of any kind over a certain time interval—neither RF pulses nor gradient pulses—which guarantees that upon transmission of A3 the data acquisition system and the patient under investigation do not experience any physical-technical change. Only the scanning operation of the system is maintained so that the scan is not interrupted, and possibly after transmission of one or more of these A3 time slices during which the system or patient can regenerate in terms of the critical quantity, the actual scan can be continued by transmitting the time slice A2 or even A1.

In the method steps S10.1 to S10.5 according to the invention, a decision about the time slice to be transmitted immediately takes place more or less in real-time through interaction of a number of MRT components (MS-DLL with integrated algorithm, monitoring software, MSW monitoring hardware MHW).

In this manner—particularly through provision of an alternative A3 that can always be transmitted without having a negative effect on the data acquisition system—it is ensured that during the entire scan no critical value is exceeded and thus the scan is not interrupted in any case. The MS-DLL must make up the acquisition of scan data at a later point in time that naturally will lengthen the scan time. This enables, for example, a monitoring scan mode (e.g., surgical intervention) that in the end run can last arbitrarily long. Moreover, if necessary—through the inventive steps S10.1 to S10.5—very intensive radiation that is limited in time can be realized. It should be added that arbitrarily many alternatives (e.g., A1 to An) for time slices—under certain circumstances depending on the selected sequence type—can be integrated into the MS-DLL and be available for use.

As mentioned above, in the decision-making for the proper or rather optimum alternative in terms of the time slice, detected (monitored) and/or computed values of the preceding time slices as well as the theoretical values of the currently running time slice are relevant. In this manner, an undesired interruption of the scan never occurs since the monitoring according to the invention of the critical quantities takes place in real-time in the following recursive cycle:

Select time slices

Check time slices

Transmit time slices

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for magnetic resonance imaging comprising the steps of:
loading data acquisition software, having a configuration, Into a computer that controls magnetic resonance imaging equipment for conducting a scan, according to said data acquisition software, of a patient disposed to interact with the magnetic resonance equipment;
executing monitoring software in said computer for estimating whether said configuration can result, during said scan, in any critical limit being exceeded;
initiating said scan according to said configuration if said monitoring software estimates that, during said scan, no critical limit can be exceeded;
in real-time during said scan, computing a time slice with said monitoring software in said computer for said scan according to said data acquisition software dependent on current value in said scan of quantities associated with said critical limit;
in real-time, transmitting said time slice from said monitoring software to said data acquisition software and continuing said scan modified as needed according to said time slice; and
in real-time, repeating computing said time slice and transmitting said time slice until said scan is completed.

2. A method as claimed in claim 1 comprising selecting said critical limit from the group consisting of limits for said equipment and limits for said patient.

3. A method as claimed in claim 1 comprising determining said current values of said critical limit with said monitoring software and transmitting said critical limit in real-time from said monitoring software to said data acquisition software in real-time.

4. A method as claimed in claim 1 comprising, in said measurement software, providing a plurality of alternative time slices for computation by said measurement software.

5. A method as claimed in claim 4 comprising, in said measurement software, making a selection, from among said plurality of alternative time slices, based on said current values of said critical limits by computing each of said plurality of alternative time slices using said current values of said critical limit and selecting one of said plurality of alternative time slices for which, with said current values of said critical limits, none of said critical limits is exceeded.

6. A method as claimed in claim 4 comprising providing a time slice, as one of said plurality of alternative time slices, consisting exclusively of an RF excitation pulse.

7. A method as claimed in claim 4 comprising providing a time slice, as one of said alternative time slices, having no radio-frequency pulses and no gradient pulses.

8. A method as claimed in claim 1 comprising, in said monitoring software, determining said critical limits prior to and during transmission of each time slice, and interrupting said scan if any of said critical limits is exceeded.

9. A method as claimed in claim 1 comprising monitoring said current values prior to and during transmission of each time slice with monitoring hardware, and interrupting said scan if said monitoring hardware indicates that any of said critical limits is exceeded.

10. A magnetic resonance apparatus for magnetic resonance imaging comprising:
magnetic resonance imaging equipment adapted to interact with a patient;
a computer loaded with data acquisition software, having a configuration, for controlling said magnetic resonance imaging equipment for conducting a scan, according to said data acquisition software, of the patient;
said computer executing monitoring software for estimating whether said configuration can result, during said scan, in any critical limit being exceeded;
said computer initiating said scan with said magnetic resonance imaging equipment according to said configuration if said monitoring software estimates that, during said scan, no critical limit can be exceeded;
in real-time during said scan, computing a time slice with said monitoring software in said computer for said scan according to said data acquisition software dependent on current values in said scan of quantities associated with said critical limit;
in real-time, transmitting said time slice from said monitoring software to said data acquisition software and continuing said scan modified as needed according to said time slice; and
in real-time, repeating computing said time slice and transmitting said time slice until said scan is completed.

11. A computer software product for magnetic resonance imaging for, when loaded into a computer that controls magnetic resonance imaging equipment adapted to interact with a patient causing said computer to:
conduct a scan, according to data acquisition software, of the a patient;
execute monitoring software for estimating whether said configuration can result, during said scan, in any critical limit being exceeded;
initiate said scan according to said configuration if said monitoring software estimates that, during said scan, no critical limit can be exceeded;
in real-time during said scan, compute a time slice with said monitoring software for said scan according to said data acquisition software dependent on current values in said scan of quantities associated with said critical limit;
in real-time, transmit said time slice from said monitoring software to said data acquisition software and to continue said scan modified as needed according to said time slice; and
in real-time, repeat computing said time slice and transmitting said time slice until said scan is completed.

12. A computer software product as claimed in claim 11 employing limits, as said critical limits, selected from the group consisting of limits for said equipment and limits for said patient.

13. A computer software product as claimed in claim 11 further causing said computer to determine said current values of said critical limits with said monitoring software and transmit said critical limits in real-time from said monitoring software to said data acquisition software in real-time.

14. A computer software product as claimed in claim 11 comprising in said measurement software, a plurality of alternative time slices for computation by said measurement software.

15. A computer software product as claimed in claim 14 further causing said computer, when executing said measurement software, to make a selection, from among said plurality of alternative time slices, based on said current values of said critical limits by computing each of said plurality of alternative time slices using said current values of said critical limit and selecting one of said plurality of alternative time slices for which, with said current values of said critical limits, none of said critical limits is exceeded.

16. A computer software product as claimed in claim 14 comprising a time slice, as one of said plurality of alternative time slices, consisting exclusively of an RF excitation pulse.

17. A computer software product as claimed in claim 14 comprising a time slice, as one of said alternative time slices, having no radio-frequency pulses and no gradient pulses.

18. A computer software product as claimed in claim 11 further causing said computer, when executing said monitoring software, to determine said current values prior to and during transmission of each time slice, and to Interrupt said scan if any of said critical limits is exceeded.

19. A computer software product as claimed in claim 11 wherein said magnetic resonance imaging equipment comprises monitoring software for monitoring said current values prior to and during transmission of each time slice and for informing said computer of said current values, and wherein said computer program product further causes said computer to interrupt said scan if said monitoring hardware indicates that any of said critical limits is exceeded.
